(19) United States
(12) Patent Application Publication
(10) Pub. No.: US 2010/0255227 A1
(43) Pub. Date: Oct. 7, 2010

(54) Decorative Door Covers

(76) Inventor: David Hisle, Boulder, CO (US)

Correspondence Address: LATHROP & GAGE LLP, 4845 PEARL EAST CIRCLE, SUITE 201, BOULDER, CO, 80301, US

(21) Appl. No.: 12/752,493

(22) Filed: Apr. 1, 2010

Related U.S. Application Data
(60) Provisional application No. 61/165,741, filed on Apr. 1, 2009.

(51) Int. Cl. B32B 1/00; B23P 11/00

(52) U.S. Cl. 428/34.1; 29/428

(57) ABSTRACT

A removable decorative cover for closet or other doors with physical dimensions adapted to fit conventional doors as found in most homes and living areas. The decorative door cover may be adapted to suit changing design needs of the home decorator.

### CROSS REFERENCE TO RELATED APPLICATION

This application claims benefit of priority to U.S. Provisional Patent Application Ser. No. 61/165,741 filed Apr. 1, 2009, which is incorporated herein by reference.

### BACKGROUND

Home decoration can be a costly and time consuming process and may require replacement or refinishing of constructed components. In many cases, a rental agreement may prevent a tenant from painting or replacing items in the home such as closet doors.

### SUMMARY

The present instrumentalities advance the art by providing removable decorative covers for closet doors with physical dimensions adapted to fit conventional closet doors as found in most homes and living areas. The decorative door cover may be adapted to suit changing design needs of the home decorator. A low cost and non-permanent alternative for quick and easy decoration is disclosed.

In an embodiment, the decorative door cover includes a material of generally rectangular shape wherein the material forms an interior chamber to partially envelop a door, said material having apertures to accommodate mechanical and physical features of the door.

In an embodiment, the decorative door cover is constructed to have a front panel, a rear panel and two side panels.

In an embodiment, the decorative door cover may be constructed of a top panel, a front panel and a rear panel. Side panels may not be required.

In an embodiment, the decorative door cover may be constructed of a front panel and a rear panel only. The front and rear panels may be connected by an adjustment mechanism as described below.

In an embodiment, the decorative door cover may have designs on either or both of the front and rear panels.

In still another embodiment the decorative door cover may be turned inside out to reveal a different design on the interior panels.

### BRIEF DESCRIPTION OF THE DRAWINGS

FIGS. 1A-D are exemplary planar front, top and bottom views of a decorative door cover according to an embodiment.

FIG. 2 is an exemplary side view of a decorative door cover according to an embodiment.

FIGS. 3A-D are exemplary front, side and rear views of a decorative door cover according to an embodiment.

FIG. 4 is an exemplary side view of a decorative door cover according to an embodiment.

FIGS. 5A-B are exemplary top views of a decorative door cover according to an embodiment.

FIG. 6 is an exemplary planar front view of a decorative door cover according to an embodiment.

### DETAILED DESCRIPTION

A decorative door cover provides an inexpensive way to redo, decorate, update and renovate a room. The decorative door cover may generally form an interior chamber with dimensions commensurate to standard doors and may be employed as an alternative to replacing or refinishing doors.

The decorative door cover may be constructed of one or more pieces of material or may be formed from one continuous piece of material. The material may be constructed to form a front panel, a rear panel, two side panels and a top panel. The panels may be fixedly attached to form an interior chamber for accommodating a door. The decorative door cover includes a non-terminated end that forms an opening to accommodate a door within the interior chamber of the decorative door cover. The decorative door cover may be constructed of front, rear and top panels and may lack side panels. The decorative door cover may form apertures for door hardware, such as knobs and hinges, to protrude from the material of the decorative door cover.

As used herein “aperture” means an opening, slit or hole.

Front and rear panels may be fixedly attached or connected to side and top panels. Panels may be fixedly attached or connected, for example, by sewing, gluing, stapling, and/or riveting. In an embodiment, seams are hidden within the interior chamber. The decorative door cover may have functional and/or decorative stitching. Functional stitching may be employed to strengthen, reinforce and/or connect decorative door cover panels. Decorative stitching may be employed to provide shape and contour or design aspects to the decorative door cover.

The decorative door cover may be used to cover conventional, generally rectangular, doors. Doors may be hinged or may comprise rollers for sliding. The decorative door cover may be adapted to cover a bifold door.

Decorative door cover material may be of a single or multiple ply (multi-ply) material. Multi-ply material may or may not form a space between adjacent layers thereof to accommodate stuffing material. For example, an interior space of the multi-ply material may be filled with a stuffing material to provide thickness to the decorative door cover and may be constructed to form a shape that provides a three dimensional contour to the decorative door cover. Stuffing material may be natural or artificial stuffing material and may be, but is not limited to, rugging, kapok, wadding, feathers, fiberfill, poly fill and cotton.

Decorative door cover material is made, for example, of textiles of natural or artificial material. Textiles may be, for instance, animal textiles, plant textiles, synthetic textiles and combinations thereof Animal textiles include, but are not limited to, wools and silks. Synthetic textiles include, but are not limited to, polyester fibers and derivatives thereof, aramid, acrylics, nylons, spandex, rayon, olefin fibers, polyactide fibers, and Lurex. Plant textiles include, but are not limited to, grass, rush, hemp, sisal, straw, bamboo, koir, kapok, cotton, flax, jute, modal, pina, ramie and tencel. Additional door cover materials include leathers and canvas.

Decorative door cover material may also be made of a rigid material such as plastic or wood veneer. Wood veneer may be employed as an alternative to replacing a scratched and or dented door. For example, a scratched and dented pine door could be covered with a cherry wood veneer door cover. Apertures for door hardware such as hinges, rollers, knobs and levers may be sized smaller than the door hardware, so that door hardware is removed prior to application of door cover, then re-applied on top of the decorative door cover. The decorative door cover may also be constructed without apertures, so that the decorator drills his/her own holes in the door cover to apply the hardware.

Decorative door covers may be made of stretchable or elastomeric material in order to form fit around a door.

As used herein, “form fit” means that a decorative door cover material fits closely to planar surfaces of the door such that there is substantially no space between the surfaces and the decorative door cover.

The decorative door cover material, for example, is knitted, woven, embroidered, crocheted, braided, and/or plaited.

Designs may be applied to front, rear and/or side panels of a decorative door cover, for example by printing, weaving, embroidery, painting, dying, appliqué, reverse appliqué, quilting, silkscreen and photographic emulsion screening. Designs may also be applied to the interior panels of the decorative door cover. The decorative door cover may thus be turned inside out and also adapted to cover a door (e.g., reversible).

Reference will now be made to the attached drawings.

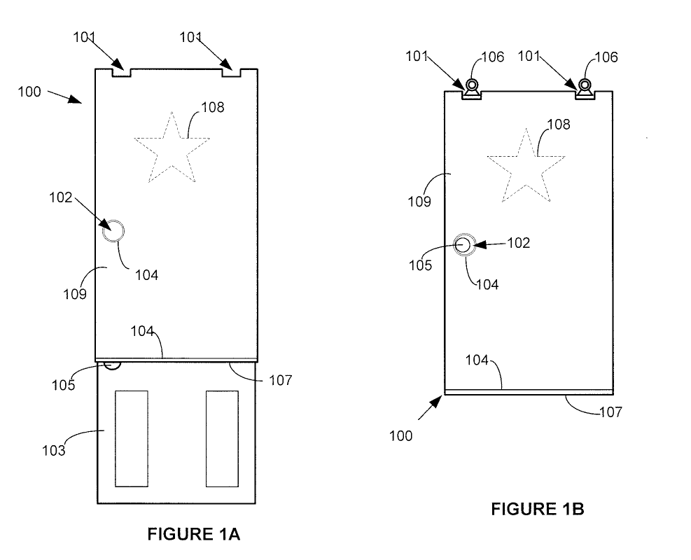

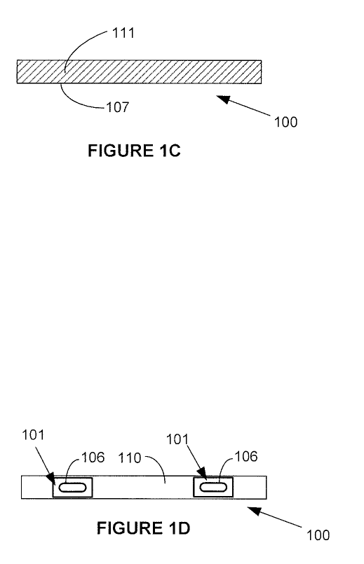

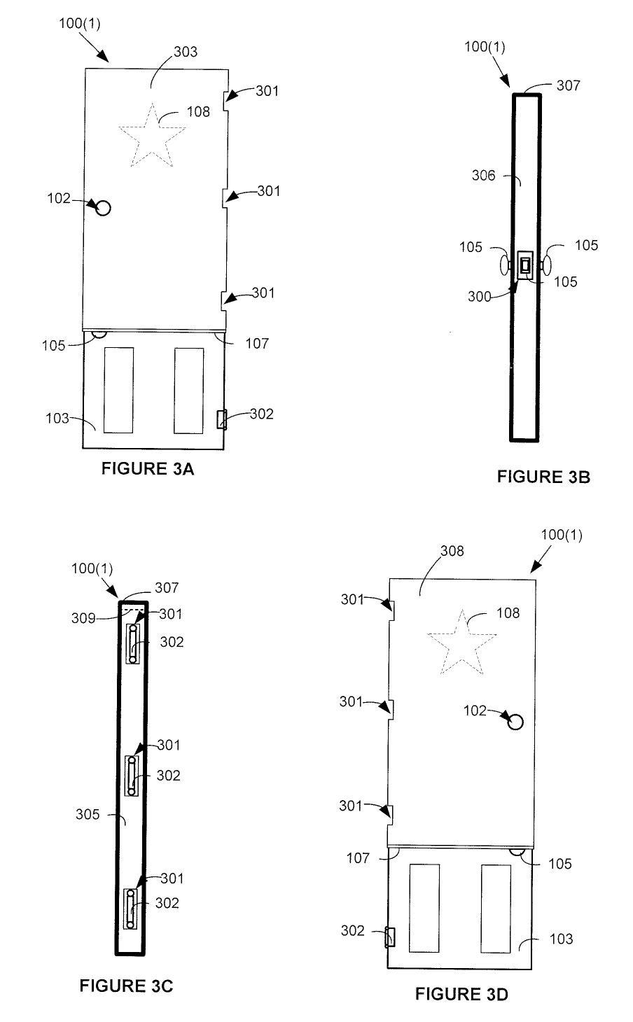

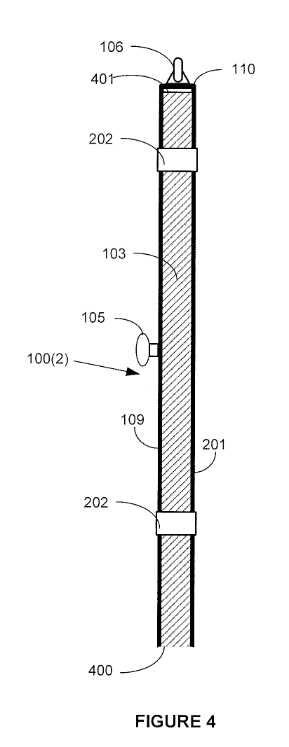

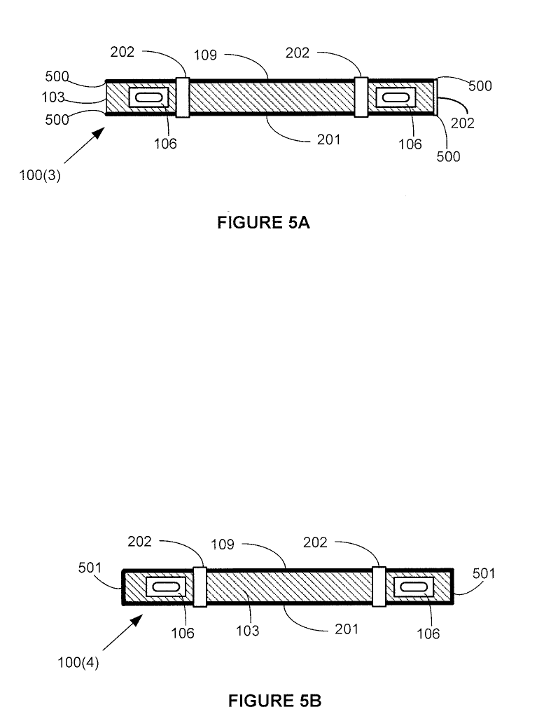

FIG. 1A shows a front view of a decorative door cover 100 partially covering a door 103, according to one embodiment. Decorative door cover 100 has apertures 101, 102 that accommodate door hardware 106, 105 respectively. Apertures 101 allow door roller hardware 106 to protrude from decorative door cover 100 without the material of decorative door cover 100 inhibiting or affecting the mechanical action of roller hardware 106. Aperture 102 allows doorknob hardware 105 to protrude from decorative door cover 100 without the material of decorative door cover 100 inhibiting the mechanical action of doorknob hardware 105. Aperture 102 may also provide access to a handle, a lever or non-protruding features of door 103, e.g. a recess or handhold. Non-terminated end 107 provides an aperture for insertion of door 103 into an interior chamber 111 of decorative door cover 100. See FIG. 1C. Stitching 104 is also shown. Design 108 is shown on front panel 109 of decorative door cover 100. It is appreciated that design 108 may vary according to the taste of a user. Item 100(1) in FIGS. 3A-3D, item100(2) in FIG. 4, item 100(3) in FIG. 5A, and item 100(4) in FIG. 5B are each embodiments of decorative door cover 100.

FIG. 1B shows decorative door cover 100 covering door 103. Doorknob hardware 105 protrudes from aperture 102. Roller hardware 106 protrudes from aperture 101. Stitching 104 is also shown. Design 108 is shown on front panel 109 of decorative door cover 100. It will be appreciated that in FIG. 1B, the sizes of apertures 101, 102 relative to hardware 106, 105 are exemplary only. For example, aperture 102 may be smaller than doorknob hardware 105 but larger than a screw (not shown) holding doorknob hardware 105 to door 103, such that doorknob hardware 105 is removed prior to application of decorative door cover 100, and replaced over decorative door cover 100(1), to provide a more continuous appearance.

FIG. 1C shows a bottom view of decorative door cover 100. Non-terminated end 107 allows insertion of door 103 into interior chamber 111 of decorative door cover 100.

FIG. 1D shows a top view of decorative door cover 100. Top panel 110 has apertures 101 to allow door roller hardware 106 to protrude from top panel 110 without the material of top panel 110 inhibiting mechanical action of roller hardware 106.

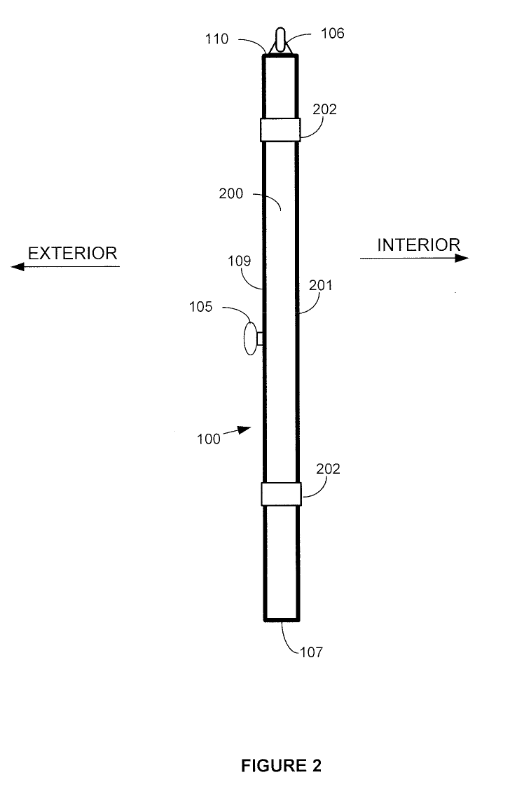

Referring now to FIG. 2, a side view of decorative door cover 100 is shown. A side panel 200 is shown. Front panel 109 faces the exterior of a closet, room, stairwell or building, for example. A rear panel 201, for example, faces the interior of the closet, room, stairwell or building. Door roller hardware 106 protrudes from aperture 101 in top panel 110. Doorknob hardware 105 protrudes from aperture 102. Non-terminated end 107 allows insertion of door 103 to the interior chamber 111 of decorative door cover 100. An adjustment mechanism 202 adjusts to create a tighter or looser fit of decorative door cover 100 to door 103. It will be appreciated that FIG. 2 shows door 103 with doorknob hardware on only its front face, for ease of illustration. Rear panel 201 may also include an aperture 102 to accommodate doorknob hardware 105 protruding from the rear face of door 103.

FIG. 3A shows a planar front view of a decorative door cover 100(1). Decorative door cover 100(1) has apertures 102 and 301 to accommodate door hardware 105 and 302. Apertures 301 allow door hinge hardware 302 to protrude from decorative door cover 100(1) without the material of decorative door cover 100(1) inhibiting the mechanical action of door hinge hardware 302. Aperture 102 allows doorknob hardware 105 to protrude from decorative door cover 100(1) without the material of decorative door cover 100(1) inhibiting access to doorknob hardware 105 by a user. Design 108 may be displayed on the front panel 303 of decorative door cover 100(1). Non-terminated end 107 allows insertion of door 103 to the interior chamber of decorative door cover 100(1). As shown, decorative door cover 100(1) partially covers door 103. Decorative door cover 100(1) for example slides down door 103 until apertures 301 align with door hinge hardware 302, aperture 102 aligns with doorknob hardware 105 and top panel 110 (see FIG. 1D) contacts the top face of door 103.

FIG. 3B shows a planar doorknob-side side view of decorative door cover 100(1). Aperture 300 in side panel 306 allows doorknob hardware 105 to protrude from side panel 306 without the material of decorative door cover 100(1) inhibiting or affecting the mechanical action of doorknob hardware 105.

FIG. 3C shows a planar hinge-side side view of decorative door cover 100(1). Top panel 307 contacts a top planar surface 309 of door 103. Apertures 301 in side panel 305 allow door hinge hardware 302 to protrude from side panel 305 without the material of decorative door cover 100(1) inhibiting the mechanical action of door hinge hardware 302.

FIG. 3D shows a planar rear view of decorative door cover 100(1). Apertures 301 allow door hinge hardware 302 to protrude from decorative door cover 100(1) without the material of decorative door cover 100(1) inhibiting the mechanical action of door hinge hardware 302. Aperture 102 present in rear panel 308 allows rear doorknob hardware 105 to protrude from rear panel 308 without the material of decorative door cover 100(1) inhibiting the mechanical action of doorknob hardware 105. As described above with respect to aperture 102, apertures 301 may be sized smaller than shown (e.g., slightly larger than screws or other hardware holding door hinge hardware 302 to door 103) such that door hinge hardware 302 is removed prior to application of decorative door cover 100(1) and re-applied over decorative door cover, to avoid gaps between door hinge hardware 302 and the material of decorative door cover 100(1).

FIG. 4 shows a planar side view of a decorative door cover 100(2). Decorative door cover 100(2) is constructed of front panel 109, rear panel 201 and top panel 110. Decorative door cover 100(2) may optionally have side panels. Adjustment mechanism 202 adjusts to create a tighter or looser fit of decorative door cover 100(2) to door 103. Adjustment mechanism 202 as shown may attach to vertical surface of front panel 109 and rear panel 201. Adjustment mechanism 202 may also attach to another surface of decorative door cover 100 such as bottom horizontal surface 400 or top horizontal surface 401 of front panel 109 and rear panel 201. In certain embodiments, adjustment mechanism 202 is at least partially concealed within interior chamber 111 of the decorative door cover.

FIG. 5A shows a top view of a decorative door cover 100(3). Decorative door cover 100(3) includes front panel 109 and rear panel 201. Front panel 109 and rear panel 201 may be connected by adjustment device 202 which adjusts to fit front panel 109 and rear panel 201 closer against door 103. Adjustment device 202 may also connect vertical sides 500 of front and rear panels 109, 201 as well as bottom, horizontal sides of front and rear panels 109, 201. Decorative door cover 100(3) may optionally include a top panel.

FIG. 5B shows a top view of a decorative door cover 100(4). Decorative door cover 100(4) includes front panel 109, rear panel 201 and side panels 501, and may optionally include a top panel. Adjustment device 202 secures decorative door cover 100(4) with door 103, and may be tightened or loosened to vary the snugness of decorative door cover 100(4), e.g., front and rear panels 109, 201, against door 103.

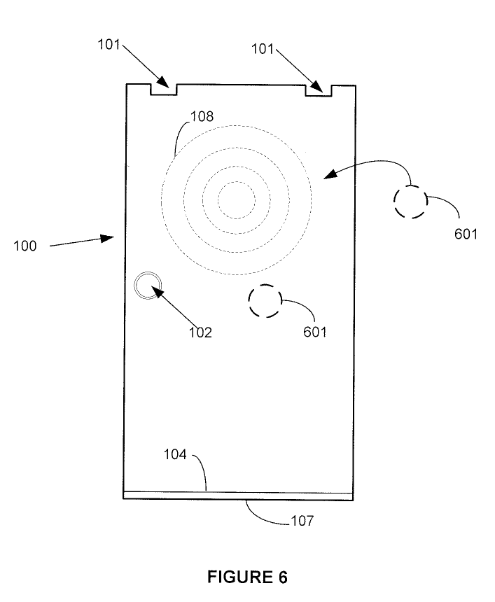

FIG. 6 shows a front planar view of decorative door cover 100. Decorative door cover 100 may comprise additional materials and accessories for modular alterations of decorative door cover 100. As shown, ball 601 may removably adhere to decorative door cover 100 by, for example, hook and loop e.g. VELCRO®. Design 108 is for example a target including hook and loop elements for “catching” ball 601 when ball 601 is thrown at the target. Alternately, ball 601 includes hook and loop elements for sticking to target 108 (or elsewhere where decorative door cover 100 includes material of suitable friction).

Decorative door cover 100, as described herein, may be constructed to form fit over standard hinged, pocket or sliding doors. For example, decorative door cover 100 may be constructed with an interior chamber 111 having dimensions to accommodate a door of about 80 inches by 30 inches. Door dimensions for example range from about 18-36 inches in width, about 76-85 inches in height and about 1.0-2.5 inches in depth. It is appreciated that interior chamber 111 may be sized to provide a custom fit for any door dimension.

Adjustment mechanism 202 may be attached to one or more panels of decorative door cover 100 to alter the fit of the decorative door cover on door 103 and to form fit door 103. Adjustment mechanism 202 may include zippers, hook and loop, e.g. VELCRO®, fasteners, magnets, buttons, adjustable straps, cords, buckles, snap buttons, cam straps, spring buckle straps, ring straps, slide release buckle straps, hooks and eyelets, elastomeric material and devices and combinations thereof. Adjustment mechanism 202 may be attached to one or more portions of side panels 200, front and rear panels 109, 201 and combinations therein so that fit may be adjusted by compressing or expanding a distance between front panel 109 rear panel 201 and/or side panel 200 and top panels 110 of decorative door cover 100. In an alternative embodiment, adjustment mechanism 202 may be attached to rear panel 201 of decorative door cover 100 and may expand or contract in the horizontal plane, vertical plane, or both.

In an embodiment, adjustment mechanism 202 may be present at non-terminated end 107.

In still another embodiment decorative door cover 100 may include one or more pockets for storage. Pockets may be transparent or opaque and may be sealable or open. Pockets may be modular and removably attached to decorative door cover 100 (e.g., via hook and loop fasteners, snaps or other fastening devices).

In an embodiment, decorative door cover 100 may include hook and loop materials and accessories for decorative alterations. For example, a VELCRO® target and balls may be incorporated into decorative door cover 100 to provide a target game. In an alternative arrangement a mini basketball backboard and net may be incorporated into decorative door cover to provide a basketball shooting game.

In certain embodiments, decorative door cover 100 is formed from a number of pieces of material, and fasteners such as stitches, snaps, rivets, staples, and/or glue secure together at least two of the pieces of material.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed:

1. A decorative door cover comprising a material of generally rectangular shape that forms an interior chamber configured to at least partially envelop a door, said material forming apertures to accommodate mechanical features of the door.

2. The decorative door cover of claim 1 further comprising a front panel, a rear panel and one or more side panels.

3. The decorative door cover of claim 1 further comprising one or more adjustment mechanisms to adjust a fit of the decorative door cover about the door.

4. The decorative door cover of claim 3 wherein the adjustment mechanism is at least partially concealed within the interior chamber of the decorative door cover.

5. The decorative door cover of claim 2 wherein the apertures are formed in one or both of the front and the rear panel of the decorative door cover.

6. The decorative door cover of claim 2 wherein the apertures are formed in a top panel of the decorative door cover.

7. The decorative door cover of claim 2 wherein the apertures are formed in one or more side panels of the decorative door cover.

8. The decorative door cover of claim 1 further comprising a design on one or more panels of the decorative door cover.

9. The decorative door cover of claim 8, wherein the design is present on an interior surface and an exterior surface of the decorative door cover.

10. The decorative door cover of claim 1, wherein the interior chamber has a width between 18-36 inches, a height between 76-85 inches and a depth of between 1.0-2.5 inches.

11. The decorative door cover of claim 1, further comprising accessories for removably attaching to one or more surfaces of the decorative door cover.

12. The decorative door cover of claim 1, wherein the material comprises one or more textiles.

13. The decorative door cover of claim 12, the one or more textiles selected from the group consisting of plant textiles, synthetic textiles and animal textiles.

14. The decorative door cover of claim 1, wherein the material is multi-ply material.

15. The decorative door cover of claim 14, the multi-ply material comprising an interior space between two adjacent layers of the multi-ply material.

16. The decorative door cover of claim 15, wherein the interior space is filled with a stuffing material.

17. The decorative door cover of claim 1, the material comprising a plurality of pieces of material, the door cover further comprising at least one fastener for securing together at least two of the plurality of pieces of material, the fastener selected from the group consisting of stitches, snaps, rivets, staples and glue.

18. The decorative door cover of claim 1, wherein the material is formed of one continuous piece of material.

19. The decorative door cover of claim 1, wherein the material is formed of a plurality of pieces of material.

20. A method of decorating a door, comprising inserting the door in a non-terminated end of a chamber of a decorative door cover, the decorative door cover configured to at least partially envelop the door and forming apertures to accommodate mechanical features of the door.
